(19) United States
(12) Patent Application Publication
(10) Pub. No.: US 2007/0191245 A1
(43) Pub. Date: Aug. 16, 2007

(54) Shaped bodies for the sanitary sector

(75) Inventors: Thomas Klein, Heidelberg (DE); Rene Graupner-Von-Wolff, Bergisch Gladbach (DE); Ralf-Johann Moritz, Neuss (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/702,402

(22) Filed: Feb. 5, 2007

(30) Foreign Application Priority Data
Feb. 16, 2006 (DE) 20 2006 002 452.2

(51) Int. Cl. C08G 69/10; C11D 17/00

(52) U.S. Cl. 510/191; 528/328

(57) ABSTRACT

The invention relates to shaped bodies for the sanitary sector, preferably shaped bodies preventing or dispersing urine scale, which are also termed WC blocks or toilet blocks, for use in the household or public commercial sanitary facilities, containing polysuccinimide in combination with polyalkylene glycols or alkyl polyalkylene glycols and/or phosphoric acid and also disintegrants.

The invention relates to shaped bodies for the sanitary sector, preferably shaped bodies preventing or dispersing urine scale, which are also termed WC blocks or toilet blocks, for use in the household or public commercial sanitary facilities, containing polysuccinimide in combination with polyalkylene glycols or alkyl polyalkylene glycols and/or phosphoric acid and also disintegrants.

### BACKGROUND OF THE INVENTION

Shaped bodies for the sanitary sector, preferably shaped bodies preventing or dispersing urine scale, are well known from the literature. An example which may be mentioned is EP-A 0 973 859 which discloses a formula containing at least one anionic surfactant, at least one nonionic surfactant, a sodium salt of carboxymethylcellulose, a solubility regulator and a fragrance in liquid, solid or microencapsulated form.

A further formula is described in EP-A 0 206 725 in which, as a speciality, organic chlorine- or bromine-releasing agents such as N-chlorosuccinimide, calcium hypochlorite, chloramine T, dichlorodimethylhydantoin and bromochlorodimethylhydantoin are used as disinfectants and anti-odour compounds. The use of chlorine as disinfectant, precisely in combination with other organic chemicals, is of ecological concern because of the possible formation of organically bound halogen. Oxygen-releasing compounds would be more advantageous ecologically; however their activity is less reliable.

Reduction of the unpleasant odour by less aggressive routes led to the use of formulas which mask unpleasant odours with pleasantly smelling fragrances and comprise, as inhibitors of urine scale formation, polyphosphates, phosphonates, polycarboxylates or complexing agents. Removal of urine scale is possible using strong acid, but this is corrosive and is not compatible with many surfactants and anionic polycarboxylates.

U.S. Pat. No. 5,833,972 and Klein et al., Wasserwirtschaft 2004, disclose polysuccinimide for its odour-reducing and calcium carbonate-reconverting properties. In EP-A 1 313 930, the limestone-reconverting property of polysuccinimide is utilized in a special tablet formulation and fatty acid derivatives are used as binder. The special feature of these tablets is the long keeping time in water. EP-A 1 489 160 describes polysuccinimide compactates which are used in washing or cleaning agents where, compared with the problem in EP-A 1 313 930, markedly more rapid dissolution times of such compactates are required. In the case of flush toilets having very short water-contact times in the range of only a few seconds, the low solubility of polysuccinimide is a serious obstacle which prevents it from being used. Polysuccinimide, particularly in the sanitary sector, would be an ideal component of shaped bodies to be used there, since in contact with alkalis it forms the dispersant polyaspartate and also together with water slowly free polyaspartic acid. A further advantage of polysuccininide is its very low hygroscopicity, since it completely lacks ionic bridge-forming or hydrogen-bond forming functional groups. Partially hydrolysed polysuccininide, as formed by reaction of polysuccinimide with water or NaOH solutions in substoichiometric amounts (based on succinimide units), is, with respect to hygroscopicity, in the middle between sodium polyaspartate and polysuccinimide. Polysuccinimide partial hydrolysates, for sanitary shaped bodies, could be a compromise between the requirements of rapid solubility and slow-release acid activity. Partially hydrolysed polysuccinimide is substantially more rapidly soluble in water than unmodified non-hydrolysed polysuccinimide. Unfortunately, the partial hydrolysates of polysuccinimide are not technically accessible, or are only technically accessible with difficulty.

### SUMMARY OF THE INVENTION

It was therefore an object of the present invention to provide compactates of polysuccinimide which form with water in a very short time the partial hydrolysates of polysuccinimide or even polyaspartic acid and thus enable use in the sanitary sector, preferably in toilets.

The solution of the object and subject matter of the present invention are shaped bodies for the sanitary sector, hereinafter also called tablets or compactates, based on polysuccinimide together with poly- or oligoalkylene glycols or alkyl polyalkylene glycols and/or phosphoric acid or sources of alkali, tablet disintegrants and/or pore formers and surfactants.

The use of poly- or oligoalkylene glycols or alkyl polyalkylene glycols, preferably polyethylene glycols, and/or phosphoric acid together with a tablet disintegrant surprisingly leads to an extremely rapid breakdown of the polysuccinimide from the shaped bodies or tablets into a water-soluble form, so that the use of PSI in shaped bodies for the sanitary sector becomes possible for the first time by this measure.

The poly- or oligoalkylene glycols act here as solvent for polysuccinimide (PSI). In this manner, PSI is soluble in triethylene glycol up to a content of 30%.

### DETAILED DESCRIPTION OF THE PREFERRED EMBODIMENTS

According to the invention, as disintegrants, use is made of swellable sheet silicates such as bentonites, natural materials and natural derivatives based on starch and cellulose, alginates, dextran and the like, potato starch, methylcellulose and/or hydroxypropylcellulose, or else microcrystalline cellulose or sugars such as sorbitol. These disintegrants can be mixed with the granules to be compressed, or they can also be already incorporated into the granules to be compressed. In addition, use can also be made, however, of hydrophilizing agents which are used for wetting the compactate particles, for example polyethylene glycol sorbitan fatty acid ester. However, gas-evolving substances, such as, for example, sodium hydrogencarbonate, in combination with citric acid or tartaric acid, can also be used.

According to EP-A-0 522 766 and thus, in a preferred embodiment, also in the present application, at least the particles which contain surfactants can be coated with a solution or dispersion of a binder/disintegrant, in particular polyethylene glycol. Other binders/disintegrants are in turn disintegrants known themselves, for example starches and starch derivatives, commercially available cellulose derivatives such as crosslinked or modified cellulose, microcrystalline cellulose fibres, crosslinked polyvinylpyrrolidones, sheet silicates etc.

The said solution proposals contribute, inter alia, in the sanitary sector to improvement of the disintegration properties of existing commercially available shaped bodies preventing urine scale. However, the improvement achieved in many cases is not sufficient. In particular when the fraction of sticky organic substances in the tablets, for example of anionic and/or nonionic surfactants, increases, or one of the ingredients itself, as in the case of polysuccinnimde, is only very poorly soluble in water, these solution proposals are not sufficient.

A preferred embodiment of the present invention is given by the simultaneous use of polysuccinimide with polyethylene glycols and/or phosphoric acid, a tablet disintegrant and/or a pore former and surfactants.

The suitability of phosphoric acid is surprising here, since to date it was only known that strongly alkaline substances such as alkali metal hydroxides or alkali metal carbonates (for example soda), silicates (for example disilicate, metasilicate) and also salts of organic and inorganic acids accelerate the hydrolysis of PSI and acids rather have a counterproductive action on solubility (Mosig et al, Ind. Eng. Chem.Res., 1997, 2163-2170). Concentrated phosphoric acid, however, is a true solvent for PSI and can therefore bring it into a molecular dispersion accelerating solubility. In solutions containing concentrated phosphoric acid, PSI can be reprecipitated out unchanged by dilution with water.

The inventive shaped bodies for the sanitary sector are primarily cylindrical shapes or tablets. The expression “shaped bodies”, however, is not restricted to the tablet shape. In principle, any spatial shape is possible which can be imposed on the starting materials, if appropriate owing to an outer container. Cylindrical bodies can have a height which is less than or greater than or equal to the diameter of the surface. However, a polygonal, for example rectangular, in particular square, but also a diamond-shaped or trapezoidal, cubic, or round or oval surface of the shaped body is also possible. Further designs include three-sided or more than four-sided surfaces of the shaped body.

The shaped bodies can be fastened into the toilet bowl by means of a basket or comparable support device on the bowl rim or be immersed as tablet in the WC cistern.

A homogeneous shaped body is taken to mean one such in which the components of the shaped body are homogeneously distributed. Heterogeneous shaped bodies are accordingly taken to mean those which do not have a homogeneous distribution of their components. Heterogeneous shaped bodies can be produced, for example, by the various components being pressed not to form a uniform shaped body, but to form a shaped body which has a plurality of layers, that is at least two layers. It is also possible that these different layers have different disintegration and dissolution rates. Advantageous service properties of the shaped bodies can result therefrom. If, for example, components are present in the shaped bodies which interact in an adverse manner, it is possible to integrate the one component into the more rapidly disintegrating and more rapidly soluble layer, and to incorporate the other component into a more slowly disintegrating layer, so that the first component can act with a start time, or already be completely reacted when the second component passes into solution. The layer structure of the shaped bodies can be stack-like, with a solution process of the inner layer(s) having already proceeded on the edges of the shaped body when the outer layers have not yet completely dissolved or disintegrated; however, complete coating of the inner layer(s) by the respectively outer lying layers can also be achieved, which leads to prevention of premature dissolution of components of the inner layer(s).

Examples of heterogeneous shaped bodies can be found, for example, in European Patent Application EP-A-0 716 144, the contents of which are hereby incorporated by the present application.

Polysuccinimide (PSI) and use thereof as conditioner for static and flowing water systems are disclosed by DE-A 101 01 671 on account of its dispersion properties, thermal stability and hardness stabilizing properties.

PSI, within the meaning of the present invention, is taken to mean PSI itself, its copolymers, partial hydrolysates or hydrolysates. Partial hydrolysates within the meaning of the present invention are polysuccinimides whose polymer building blocks have been partly converted to aspartate units, that is copolymers of succinimide units and aspartate units. These partial hydrolysates can also be in spray-granulated form.

PSI can be produced on an industrial scale by thermal polymerization of maleic anhydride and ammonia or derivatives thereof (see U.S. Pat. No. 3,846,380; U.S. Pat. No. 4,839,461; U.S. Pat. No. 5,219,952 or U.S. Pat. No. 5,371,180).

In addition, PSI are obtained by thermal polymerization of aspartic acid (U.S. Pat. No. 5,051,401) if appropriate in the presence of acidic catalysts/solvents (U.S. Pat. No. 3,052,655).

PSI is produced in chemical synthesis as a polymer having a mean molar weight of 500 to 20 000, preferably 3000 to 5000. Polysuccinimide is considered a chemical precursor of polyaspartic acid to which it slowly hydrolyses with water. The pH of the resultant solution is from pH 1 to 4, preferably 2 to 3. As a result, not only the good scale-dissolving activity, but also simultaneously the dispersing activity of the polyaspartic acid liberated by PSI comes into effect against the sparingly soluble calcium salts and other sparingly soluble substances. The resultant acidic solution, owing to its acid activity, also leads to the direct dissolution of any calcium carbonate incrustations formed.

The PSI to be used according to the invention is used in the shaped bodies to be used in the sanitary sector in amounts of 0.01 to 90% by weight, preferably 0.1 to 40% by weight, and particularly preferably in an amount of 0.5 to 20% by weight.

The poly- or oligoalkylene glycols or alkyl polyalkylene glycols, preferably polyethylene glycols, to be used according to the invention are used in amounts of 0.1-80% by weight, preferably in amounts of 0.5-40% by weight, in the inventive shaped bodies for the sanitary sector.

Polyethylene glycols suitable according to the invention are those having a low degree of ethoxylation, for example polyethylene glycols having a molecular weight of less than 2000, preferably 100 to 1000, particularly preferably 100 to 600.

When phosphoric acid is used, the phosphoric acid to be used according to the invention in the shaped bodies for the sanitary sector is used in an amount of 0.5% by weight to 25% by weight.

The disintegrants preferably to be used according to the invention in the shaped bodies for the sanitary sector which are to be converted into a granular or co-granulated form include starch and starch derivatives, cellulose and cellulose derivatives, for example microcrystalline cellulose, CMC, MC, alginic acid and salts thereof, carboxymethylamylopectin, polyacrylic acid, polyvinylpyrrolidone and polyvinylpolypyrrolidone. The disintegrant granules can be produced in a conventional manner, for example by spray-drying or hot-steam drying of aqueous preparation forms or by granulation, pelleting, extrusion or roller compacting. It can be advantageous to add to the disintegrants additives, granulation aids, supports or lamination aids of the known type (cogranulated form). Additives, in a preferred embodiment of the invention, are non-surfactant active ingredients of washing or cleaning compositions, in particular bleach activators and/or bleach catalysts, particular preference here is given to disintegrant granules which contain as additive tetraacetylethylenediamine (TAED) and/or other bleach activators of the customary type. Such disintegrant granules can advantageously be produced by cogranulation of the disintegrant with the additive. By means of such a cogranulation, the distribution of the disintegrant in the shaped body, in particular in the tablet, can be enlarged, which in certain cases can likewise lead to an improvement of the disintegration rate of the shaped body.

The amounts of such disintegrants used are disclosed to those skilled in the art by DE-A 197 10 254, the contents of which are incorporated by the present application.

As further compositions supporting the dissolution of the shaped bodies for the sanitary sector those suitable are, in addition, substances which have alkalinity; that is substances which in aqueous solution have a pH above 7. The dissolution-supporting action of such substances is based on an acceleration of the hydrolysis of polysuccinimide. According to the invention, the shaped bodies for the sanitary sector preferably contain components additionally accelerating the hydrolysis of polysuccinimide of the series soda, silicates (for example disilicate, metasilicate) or salts of organic or inorganic acids.

According to the invention the inventive shaped bodies for the sanitary sector contain surfactants as further components. Primarily these include aniomic, nonionic, cationic, amphoteric or zwitterionic surfactants. In addition, the inventive shaped bodies can contain further components, preferably inorganic and organic, water-soluble or water-insoluble builder substances and cobuilders, bleaches, in particular peroxide bleach, but also activated chlorine compounds which are advantageously coated, bleach activators or bleach catalysts, enzymes and enzyme stabilizers, foam inhibitors or dyes and fragrances. The preferred anionic surfactants include not only those which are petrochemically based, preferably alkylbenzenesulphonates, alkanesulphonates or alkyl(ether) sulphates having uneven chain lengths, but also those on a native basis, preferably fatty alkyl sulphates or fatty alkyl(ether) sulphates, soaps, sulphosuccinates etc. Of particular preference are, if appropriate in combination with small amounts of soap, alkylbenzenesulphonates and/or various chain lengths of alkyl sulphates and alkyl ether sulphates. Whereas in the case of alkylbenzenesulphonates the C₁₁-C₁₃-alkylbenzenesulphonate and C₁₂-alkylbenzenesulphonate are preferred, in the case of the alkyl(ether) sulphates, preferred chain lengths are C₁₂ to C₁₆, C₁₂ to C₁₄, C₁₄ to C₁₆, C₁₆ to C₁₈, or C₁₁ to C₁₅ or C₁₃ to C₁₅.

The preferred nonioinc surfactants include, in particular, those having on average 1 to 7 mol of ethylene oxide per mol of alcohol of ethoxylated C₁₂-C₁₈-fatty alcohols and the corresponding C₁₁-C₁₇-alcohols, in particular C₁₃-C₁₅-alcohols, but also the amine oxides, alkyl polyglycosides, polyhydroxy fatty acid amides, fatty acid methyl ester ethoxylates, gemini surfactants and higher ethoxylated alcohols of the stated chain length known from the washing or cleaning agents sector.

As pore formers to be used according to the invention in the shaped bodies for the sanitary sector, use is preferably made of zeolites. Particularly preferably according to the invention use is made of zeolite A, zeolite P, zeolite X or any desired mixtures thereof. The pore formers are used in the shaped bodies for the sanitary sector in amounts of 1 to 60% by weight, preferably in amounts of 2 to 20% by weight.

The dissolution behaviour of the PSI-containing shaped bodies for the sanitary sector preventing or dissolving urine scale was studied using fluorescence spectroscopy. Thus an aqueous solution of the thermally produced polyaspartic acid, after excitation by UV light having a maximum at 334 nm, exhibited a fluorescence emission at 411 nm (in the maximum).

The actual production of the inventive shaped bodies for the sanitary sector preventing or dissolving urine scale proceeds first by mixing with the remaining components and subsequent shaping, in particular compression moulding, to form shaped bodies or tablets, or extrusion, if appropriate hot, it being possible to use customary methods (for example as described in the conventional patent literature on tabletting, in particular as in the abovementioned patent applications and the article “Tablettierung: Stand der Technik” [Tabletting: State of the Art], SOFW-Journal, volume 122, pp. 1016-1021 (1996)).

It will be understood that the specification and the examples are illustrative but not limitative of the present invention and that other embodiments within the spirit and scope of the invention will suggest themselves to those skilled in the art.

### EXAMPLES

### Example 1

Production of Inventive Shaped Bodies for the Sanitary Sector

In a laboratory kneader, 200 g of finely ground polysuccinimide (particle size 90%<120 μm), 400 g of triethylene glycol, 10 g of Na₂CO₃, 100 g of lauryl alcohol ethoxylate (30 EO), 90 g of dodecylbenzenesulphonate, 50 g of polyvinylpyrrolidone and 150 g of zeolite P were mixed intimately at 60° C.

Strands having a diameter of 12 mm were shaped via an extruder; subsequently the strands were sliced into short pieces (approximately 2.5 cm in length) and allowed to cool.

Two shaped bodies obtained in this manner were packed into an appropriate column (diameter approximately 4 cm) as used for instance in column chromatography. 2 l of tap water of 14° dH was charged from the top. The outflow is set in such a manner that the water was completely run out of the column after approximately 60 s.

In the eluate thus obtained, the polyaspartic acid concentration was determined by fluorescence spectroscopy at the excitation wavelength 336 nm and emission wavelength 411 nm.

### Example 2

Production of Non-inventive Shaped Bodies

400 g of polysuccinimide, 100 g of triethylene glycol, 500 g of polyethylene glycol (molar mass 6000) were mixed intimately in a laboratory kneader at 60° C. Shaped bodies were obtained via an extruder in a similar manner to Example 1.

### Example 3

Production of Non-inventive Shaped Bodies

900 g of polysuccinimide and 100 g of stearic acid (Example 3a) or 100 g of polyethylene glycol MW 6000 (Example 3b) were mixed in a laboratory mixer and compressed using a rotary tabletting machine to give tablets having a diameter of 2.5 cm.

In a column, shaped bodies of Examples 2, 3a and 3b were eluted with 2 l of tap water in a similar manner to Example 1. In the collected eluate, no polyaspartic acid was detected using fluorescence spectroscopy (detection limit 0.5 ppm).

### Example 4

Production of Inventive Shaped Bodies

In a laboratory kneader, 400 g of finely ground polysuccinimide partial hydrolysate (production see below), 200 g of triethylene glycol, 200 g of lauryl alcohol ethoxylate (30 EO), 50 g of dodecylbenzenesulphonate, 50 g of polyvinylpyrrolidone and 100 g of zeolite P were mixed intimately at 60° C.

Shaped bodies were obtained via an extruder. Using an elution experiment, the release of polyaspartic acid to water was studied.

When 2 l of tap water (14° dH) were used, 22 ppm of polyaspartic acid were detected in the eluate.

### Example 5

Production of Non-inventive Shaped Bodies

1000 g of polysuccinimide powder were sprayed with 100 g of water in a Lodige mixer. The pasty mass was extruded in a laboratory extruder and dried in a fluidized bed.

In the elution experiment, 1 ppm of polyaspartic acid was detected. This was too little for the flushing operation in the toilet; as a slow-release form available in the long term for polyaspartic acid, however, the extrudate was suitable.

Production of Partial Hydrolysates of Polysuccinimide

Batch:

From 500 g of Baypure® DSP (pure polysuccinimide as solid) of Lanxess Deutschland GmbH and 615 g of water, a suspension was produced and homogenized by rotor/stator (X40/38E2) at stage 2. Then the pH (see table) was measured and the suspension sprayed.

Granulation:

Drying and granulation proceeded in a laboratory fluidized bed granulator (for example GPCG3) under the conditions stated in the table. After approximately 30 minutes in each case this was terminated and the coatings removed from wall and bottom and if appropriate ground in a mortar. Thereafter the remainder of the solution/suspension was sprayed, an attempt being made to keep the product temperature as low as possible. The resultant materials were sieved through a 1 mm sieve, in order to remove very large agglomerates. In all experiments the granulation was good, but also a lot of dust was produced which permitted the conclusion that the material dries rapidly. Free-flowing materials were obtained which consisted of hard and brittle particles the majority of which were less than 0.5 mm. The bulk density ranged between 400 and 480 g/l which was due in part to the high dust content.

TABLE
Laboratory experiments for producing polysuccinimide partial hydrolysate

| | | | Feed air | Exhaust air | Product | Spraying | Amount |
|---|---|---|---|---|---|---|---|
| | Amount | | temp. | temp. | temp. | pressure | after |
| Experiment | of water g | pH | ° C. | ° C. | ° C. | bar | sieving g |
| E1 | 615 | 4.5 | 140 | 65–80 | 70–80 | 1.0 | 340 |

By means of IR spectroscopy (carbonyl bands of polysuccinimide as indicator of content), the polysuccinimide content was determined as 40%. Thus a partial hydrolysate is obtained, the polyaspartic acid fraction of which was 60%.

1. A shaped body containing polysuccinimide, poly- or oligoalkylene glycols or alkyl polyalkylene glycols and/or phosphoric acid, tablet disintegrants and/or pore formers and surfactants.

2. A shaped body according to claim 1, wherein the polyalkylene glycol is polyethylene glycol.

3. A shaped body according to claim 1, wherein the surfactant is anionic, nonionic, cationic, amphoteric or zwitterionic.

4. A shaped body according to claim 3, wherein a petrochemical-based anionic surfactant is used.

5. A shaped body according to claim 4, wherein the petrochemical-based anionic surfactant is alkylbenzenesulphonate, alkanesulphonate or alkyl(ether) sulphate having uneven chain lengths, or a native-based anionic surfactant.

6. A shaped body according to claim 5, wherein the native-based anionic surfactant is fatty alkyl sulphate or fatty alkyl(ether) sulphate, soap or sulphosuccinate.

7. A shaped body according to claim 3, wherein the nonionic surfactants have on average 1 to 7 mol of ethylene oxide per mol of alcohol of ethoxylated C₁₂-C₁₈-fatty alcohols and the corresponding C₁₁-C₁₇-alcohols, higher ethoxylated alcohol of the stated chain length, amine oxide, alkyl polyglycoside, polyhydroxy fatty acid amide, fatty acid methyl ester ethoxylate gemini surfactant.

8. A shaped body according to claim 7, wherein the alcohol is a C₁₃-C₁₅-alcohol.

9. A shaped body according to claim 1, wherein the pore former is a zeolite.

10. A shaped body according to claim 9, wherein the Zeolithe is zeolite A, zeolite P, zeolite X or any desired mixture thereof.

11. A shaped body according to claims 1 additionally containing dissolution-supporting substances.

12. A shaped body according to claim 11, wherein the dissolution-supporting substance is soda, silicate or a salt of an organic or inorganic acid.

13. A shaped body according to claim 1 containing additional inorganic and organic, water-soluble or water-insoluble builder substances and cobuilders, bleaches, in particular peroxide bleaches, activated chlorine compounds, bleach activators and bleach catalysts, enzymes and enzyme stabilizers, foam inhibitors or dyes and fragrances.

14. A method of using a shaped body according to claim 1 for the sanitary sector.

15. A method of use according to claim 14 wherein the sanitary sector are toilets.

16. A process for manufacturing shaped bodies according to claim 1 wherein finely ground polysuccinimide or finely ground polysuccinimides partial hydrolysate is mixed with a poly- or oligoalkylene glycol or alkyl polyalkylene glycol and/or phosphonic acid, tablet disintegrants and/or pore formers and surfactants in a kneader and the mixture is then pressed to shaped bodies via an extruder.

17. A process according to claim 16 wherein additionally dissolution-supporting substrates are used.
